(19) United States
(12) Patent Application Publication
(10) Pub. No.: US 2019/0122243 A1
(43) Pub. Date: Apr. 25, 2019

(54) Social Digital Token Mining and Marketplace System

(71) Applicant: Thomas Mizzone, Port Murray, NJ (US)

(72) Inventor: Thomas Mizzone, Port Murray, NJ (US)

(21) Appl. No.: 16/156,478

(22) Filed: Oct. 10, 2018

Related U.S. Application Data
(60) Provisional application No. 62/574,658, filed on Oct. 19, 2017.

(51) Int. Cl. G06Q 30/02; G06Q 50/00

(52) U.S. Cl. CPC G06Q 30/0217; G06Q 50/01

(57) ABSTRACT

An internet-based social marketplace establishes an economy that runs on a standardized “reward token,” allowing users to be incentivized to promote across multiple brands. The reward tokens can be redeemed in a global marketplace spanning multiple brands. In addition, through the common marketplace, brands can access new users who are interested in the brand's rewards in the rewards marketplace. If and once available on a public exchange, the reward tokens can be purchased directly from users, excess tokens can be resold and users can transfer reward tokens for redemptions in the rewards marketplace.

### REFERENCE TO RELATED APPLICATION

This application claims the benefit of the filing date of U.S. Provisional Patent Application No. 62/574,658, filed on Oct. 19, 2017, which is incorporated herein by reference.

### FIELD OF INVENTION

The present invention relates to the general field of digital tokens and more particularly to a reward token which is transferred to users through incentivized social actions on behalf of sponsoring brands and which circulates within a global social actions marketplace.

### BACKGROUND OF THE INVENTION

With the modern trend toward proliferation and intensification of social media activity, many commercial brands—especially those associated with entertainment and sports—have acquired a “fan base.” Such fans will regularly engage in various social media activities related to the commercial brand. For example, a fan of a popular musical artist may share a video on his/her Facebook page, Tweet about an upcoming concert, view a YouTube video of the artist's performance, listen to an audio track, or check in at an event.

In each of such instances, the fan's social actions have commercial value in promoting the relevant brand. The technical challenge has been how best to optimize social promotion and monetize this untapped commercial potential. Ultimately, this challenge relates to the formation of a global marketplace for brand-promoting social actions.

Creating and sustaining such a global social action marketplace demands the concomitant creation of a common medium of exchange—in effect, a dedicated “reward token.” In order to maximize the value to the sponsoring brands, such a reward token would optimally be designed to be issued from and circulate primarily within the brand's own social action and rewards marketplace. For example, the music artist's fan who earns one reward token for his/her Tweet would be directed to a “rewards” page, where he/she would redeem the reward token for, say, a back-stage pass to the artist's next concert. In this way, the reward token circulates back to the sponsoring brand, from which it can be reissued to incentivize further social activity on behalf of the brand. Such re-circulation allows the social action marketplace and its associated reward token to become self-sustaining.

In order to maximize and globalize the commercial potential of such a social action marketplace, however, it is imperative that such a marketplace not be fragmented. Therefore, an optimal system must avoid the “silo” paradigm, in which each brand issues and circulates its own “points” based reward that is not readily convertible into “points” of other brands. Establishing an economy that runs on a standardized “reward token” allows users to be incentivized to promote across multiple brands, and the reward tokens can be redeemed in a global marketplace spanning multiple brands. In addition, through the common marketplace, brands can access new users who are interested in the brand's rewards in the rewards marketplace. If and once available on a public exchange, the reward tokens can be purchased directly from users, excess tokens can be resold and users can transfer reward tokens for redemptions in the rewards marketplace.

### SUMMARY OF THE INVENTION

The present invention is a method for creating and sustaining an internet-based global marketplace for monetized social actions performed by fans on behalf of multiple sponsoring brands. The method is implemented by embedding application software (the “App”) on the websites of the sponsoring brands. From the brand websites, the App connects to a “software as a service” (SaaS) web platform, which provides an API access to a database of available social actions, some of which are directly integrated with the major social media platforms. The App includes a user interface through which fans can join the social marketplace as social action “vendors” and brands reward “users.” In some embodiments of the present invention, fans perform promotional social actions through the App embedded on the brand's website. In other embodiments, the fan performs social actions through native social media apps, once the fan has joined the brand's program and integrated social network accounts. In still other embodiments, the fan uses one or more native or hybrid apps alternatively to or in conjunction with the embedded brand App in performing brand-promoting social actions.

Rewarding the fans' social activity is achieved through the issuance of a universal cross-brand reward token, which is a utility token issued on a block-chain protocol. The value of a reward token would fluctuate in value relative to the USD based primarily on the value that buyers and sellers in the market attach to the token in the context of arms-length transactions.

The reward token is initially put into circulation in the social marketplace through “seed allocations” to the sponsoring brands, with the size of each seed allocation being determined by the number of each brand's fans and the level of their social activity. The sponsoring brands will each establish a “normalized” USD value equivalent for rewarding promotional social actions as well as for each of the rewards they offer fans, and the App/SaaS platform will convert the USD value to the reward token equivalent, based on the current market USD value of the reward token, if publicly traded, or a fixed arbitrary value if not.

The platform establishes a normalized USD value for various social media fan actions to be incentivized which is controlled by the brands on the platform. Referring to the previous example of a musical artist's brand, for instance, a fan action of following the artist on Twitter could be worth $0.50, which value would then be converted by the App/SaaS to 50 reward tokens if the fixed value or market value for the reward token were $0.01. The 50 reward tokens would then be deposited in the fan's “virtual wallet,” with the transaction being tracked in a blockchain ledger. In some embodiments of the present invention, fans can also obtain reward tokens by purchasing them in exchange for USD from an internal exchange of the rewards marketplace, if the reward tokens are not publicly traded, or from a public exchange if the tokens are publicly traded. Such purchased reward tokens can be used to access rewards faster, get into VIP programs, and/or unlock exclusive content. In other embodiments, non-fans can also purchase reward-tokens in an internal exchange or public exchange and can use these reward tokens for redemption of brand rewards.

In effect, therefore, the method of the present invention involves a process of “social mining” of the reward tokens, since a fan's brand-promoting social activity generates block-chain tracked reward tokens in the same way that data mining generates cryptocurrencies.

The major distinguishing feature of the present invention, however, is that it concurrently creates a social action marketplace used across brands, in which the reward token functions as a true medium of exchange rather than an investment. Furthermore, because the reward token of the present invention continually circulates and re-circulates back to its issuing sources in the social marketplace, the social token and the social marketplace are both self-sustaining and mutually sustaining.

The foregoing summarizes the general design features of the present invention. In the following sections, specific embodiments of the present invention will be described in some detail. These specific embodiments are intended to demonstrate the feasibility of implementing the present invention in accordance with the general design features discussed above. Therefore, the detailed descriptions of these embodiments are offered for illustrative and exemplary purposes only, and they are not intended to limit the scope of the foregoing summary description.

### BRIEF DESCRIPTION OF THE DRAWINGS

FIG. 1 is a schematic diagram of an exemplary web platform for a global social marketplace, according to one embodiment of the present invention;

FIG. 2 is a schematic diagram illustrating an exemplary global marketplace for earning and redeeming normalized reward tokens, according to one embodiment of the present invention;

FIG. 3 is a schematic diagram illustrating an example of a fan “social mining” for reward tokens, according to one embodiment of the present invention;

FIG. 4 is a schematic diagram illustrating exemplary social reward token mining transactions, according to one embodiment of the present invention;

FIG. 5 is a schematic diagram illustrating exemplary re-circulation of reward tokens in the social marketplace, according to one embodiment of the present invention;

FIG. 6 is an exemplary flow diagram for the reward token transactions, according to one non-publicly traded embodiment of the present invention; and

FIG. 7 is an exemplary flow diagram for reward token transactions, according to one publicly traded embodiment of the present invention.

### DETAILED DESCRIPTION OF THE PREFERRED EMBODIMENTS

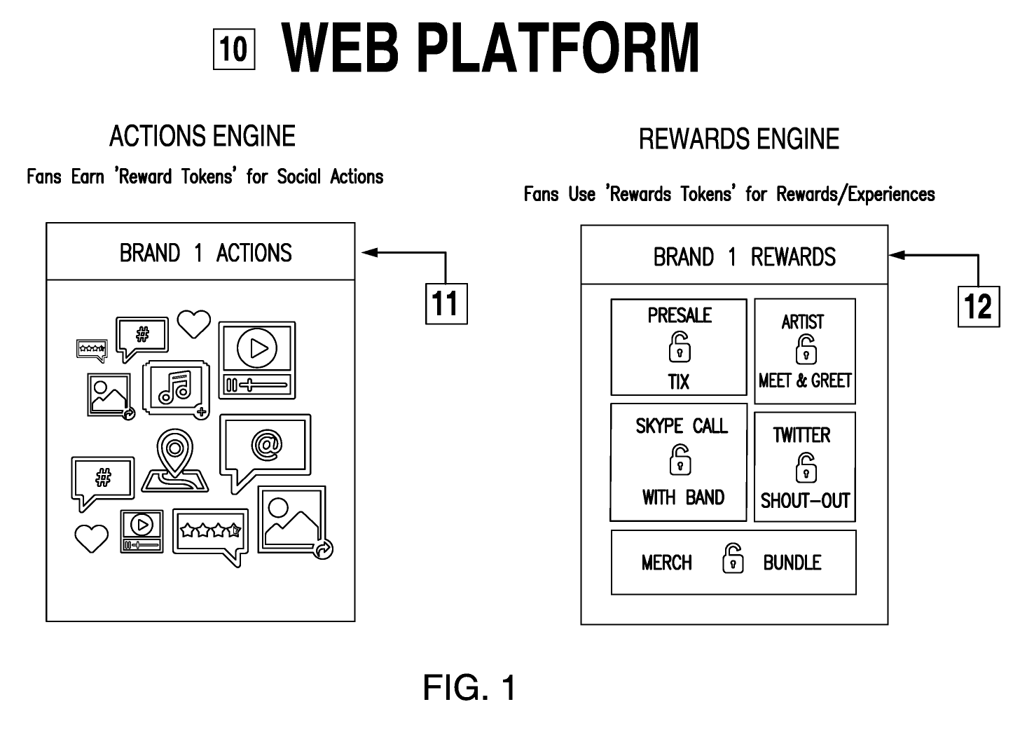

Referring to FIG. 1, an exemplary web platform 10 for a global social marketplace provides one or more menus of social actions 11 from which a participating fan can select one or more social activities to perform on behalf of a brand in exchange for reward tokens. The platform 10 also provides one or more menus of fan rewards 12, which can be redeemed using the reward tokens earned from the social actions 11.

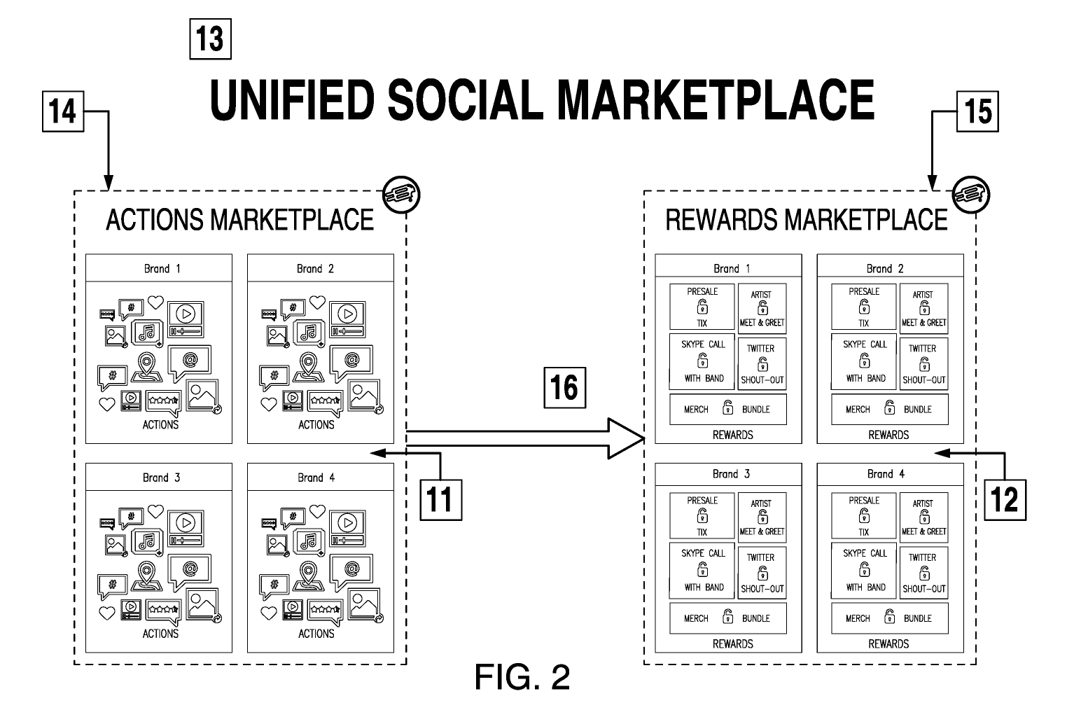

FIG. 2 illustrates an exemplary global marketplace 13, consisting of an actions marketplace 14, comprising multiple social action menus 11 associated with sponsoring brands, and a rewards marketplace 15, comprising multiple rewards menus 12 associated with these brands. Instead of a “siloed” closed platform, normalized reward token values allow users to earn and redeem reward tokens across brands 16. Reward tokens become available for purchase and sale in either an internal exchange or a public exchange, so that the tokens have a fluctuating exchange rate relative to the USD based on supply and demand for the token. In one embodiment, non-fans can also purchase reward tokens for USD and use the tokens in the rewards marketplace 15.

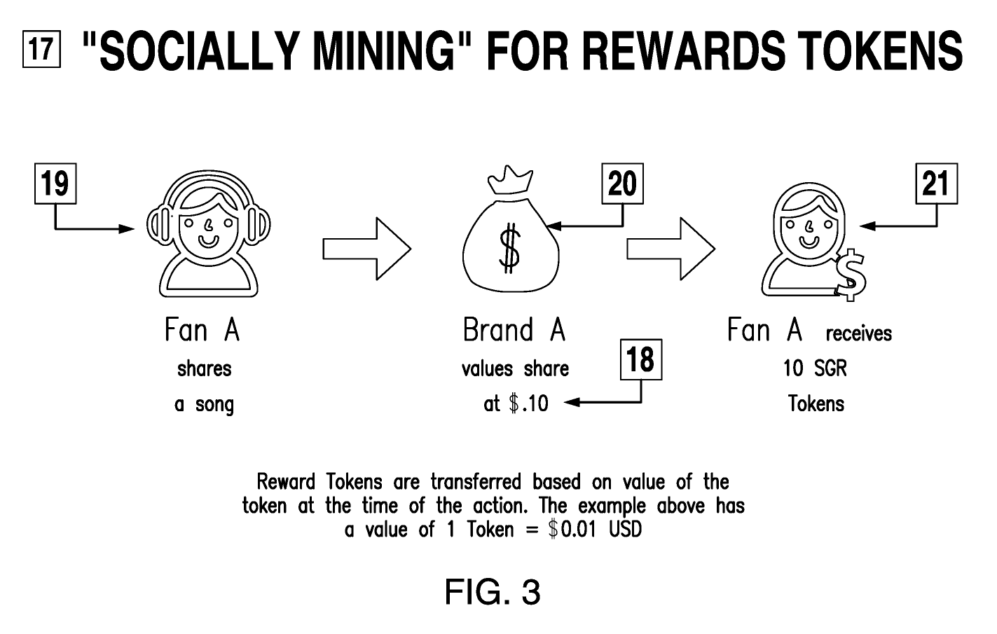

An example of a fan's “social mining” for reward tokens is illustrated in FIG. 3. Here, the reward token is called a “Sugar” (SGR) token, having a current exchange rate 17 of 1 SGR=$0.01 USD. Brand A sets a value 18 of $0.10 USD for a fan's social action 19 of sharing a song, so that when Fan A shares a song 19, Brand A pays the token equivalent of $0.10 USD 20, which Fan A receives in his/her virtual wallet in the form of 10 SGR reward tokens 21.

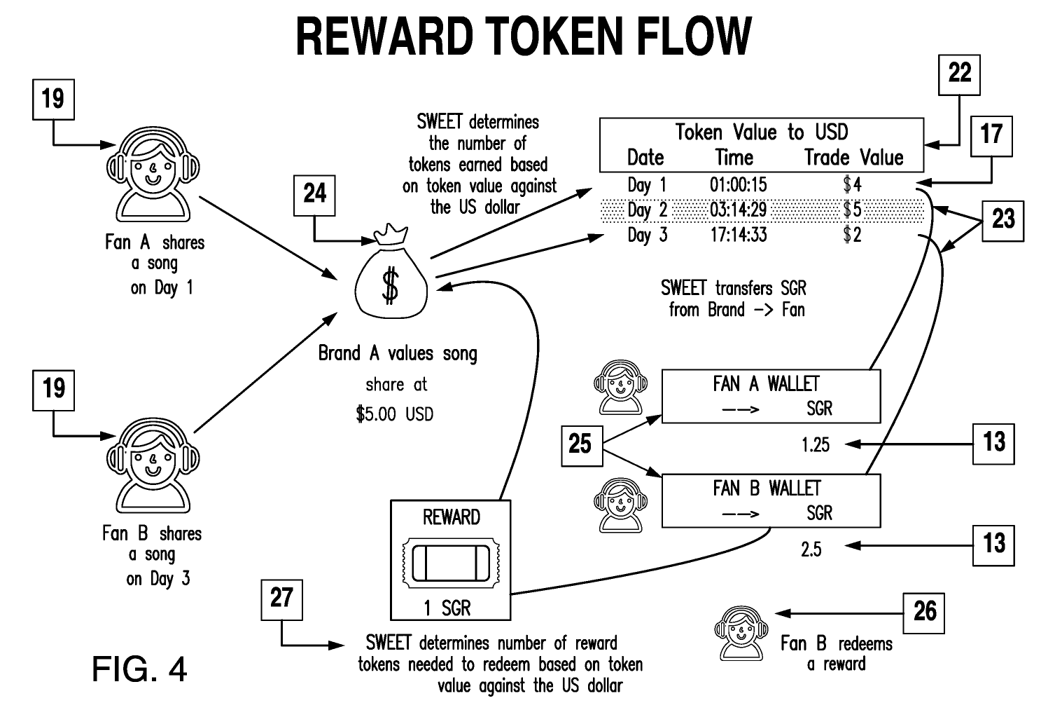

In the example shown in FIGS. 4, the SGR tokens are publicly traded on an exchange 22, so that their exchange value against the USD 17 is constantly fluctuating and set by supply and demand forces in the broader marketplace. The Web Platform 10, in this example designated as “SWEET,” will convert the USD equivalent of the brand points award value 18 to the corresponding number of SGR tokens 23 based on the trading value of the SGR token 17 at the time of the award 24. In this example, since Fans A and B performed their social actions 19 at different times, the actual number of SGR tokens 13 deposited in their respective virtual fan wallets 25 will differ. Similarly, when the fans redeem their SGR reward tokens for rewards 26, the SWEET platform 10 checks the exchange 22 to determine the number of SGR tokens needed to redeem the selected reward 27 based on the current SGR trading value 17.

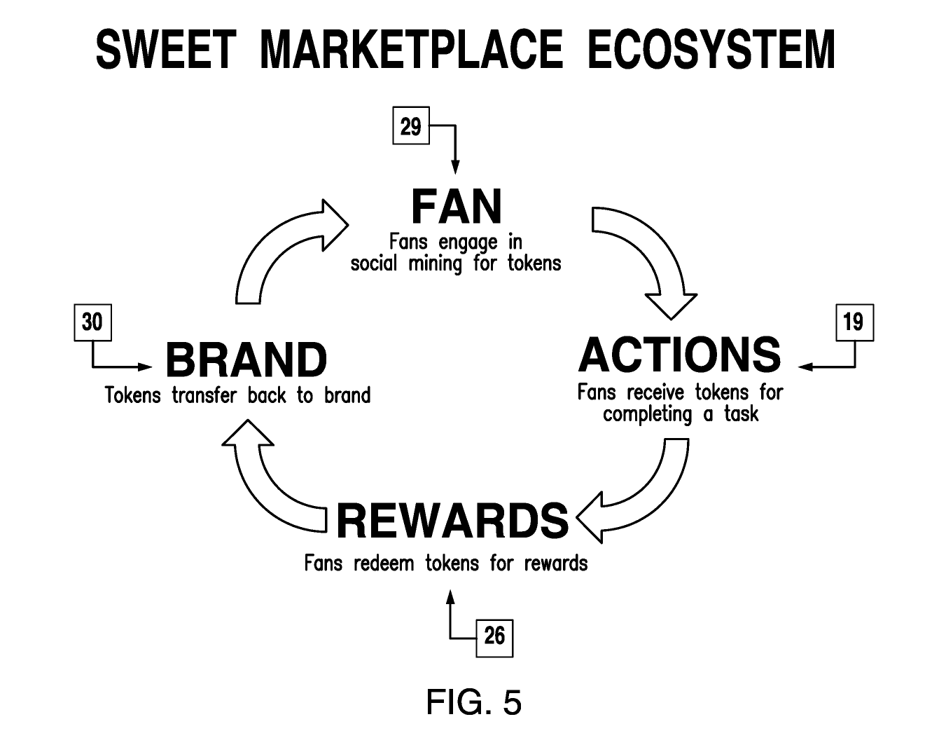

Referring to FIG. 5, an exemplary SWEET Marketplace Ecosystem 28 is illustrated, showing how SGR tokens are re-circulated in the Social Marketplace 28. Fans engage in social mining of the reward tokens 29 by performing brand-promoting social actions 19. The SGR tokens are then re-circulated back to the issuing brand 30 when the fan redeems his/her tokens for rewards 26. All SGR reward token transactions are tracked and recorded in SWEET's blockchain ledger.

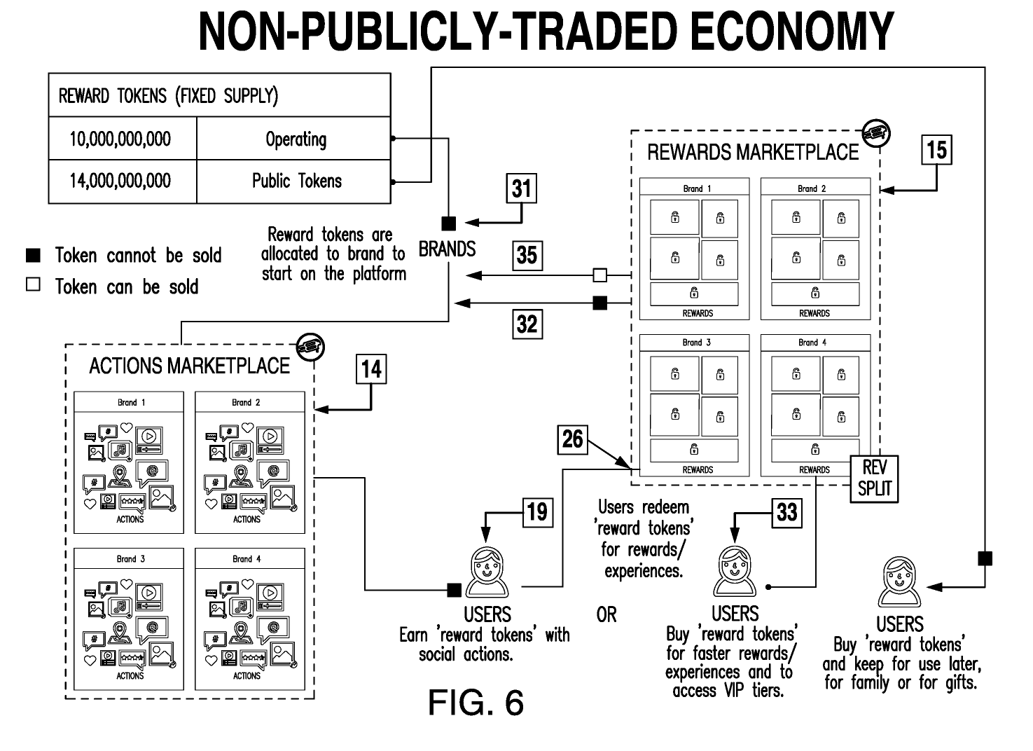

FIG. 6 is a flow diagram for embodiments of the present invention in which the reward tokens are not publicly traded. Beginning with a normalized token value of $0.01 USD, tokens are allocated to brands 31, based on the size and social activity of their fan base. In the actions marketplace 14, fans earn reward tokens by performing social actions 19. When the fan redeems their reward tokens 26 in the rewards marketplace 15, these reward tokens return to the brand 32. Fans can purchase additional tokens 33 from the internal exchange 34 to access rewards faster, or for “micro-transactions” which unlock exclusive content or provide access to VIP programs. Incremental tokens 33 purchased by fans transfer back to the brand 35 upon redemption or micro-transaction.

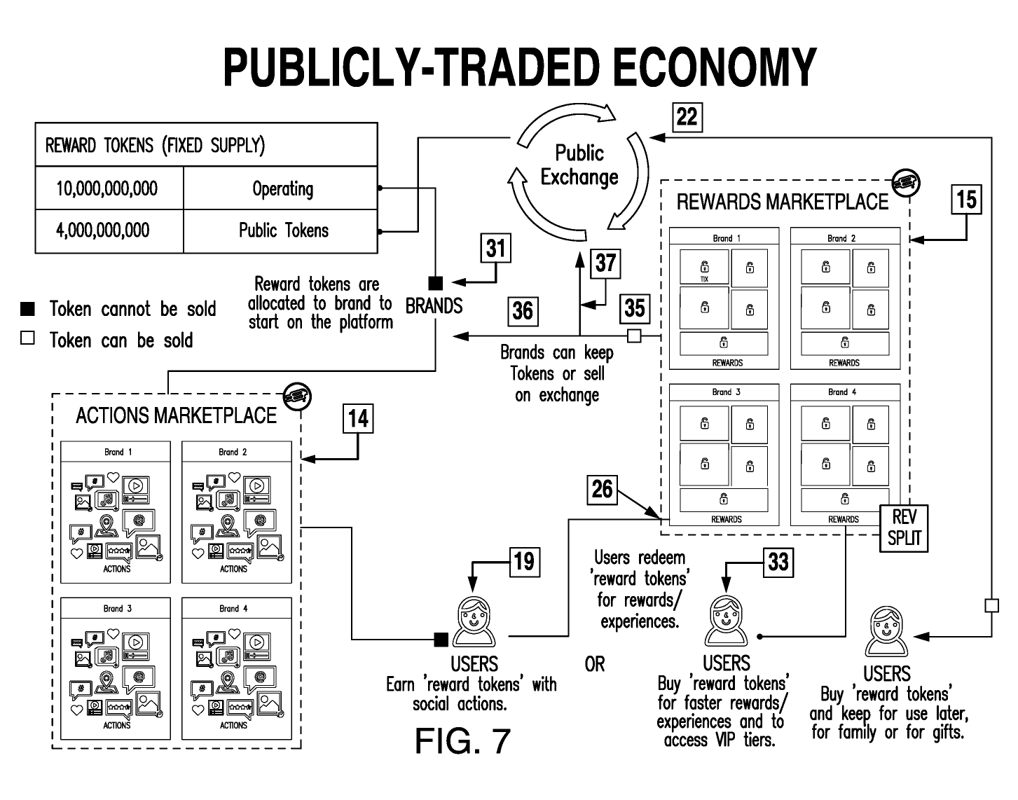

Referring to FIG. 7, the flow for embodiments with publicly-traded reward tokens is similar to that of the non-publicly-traded embodiments, insofar as there is initial token allocations to the brands 31, earned rewards in the action's marketplace 14 for fans' social actions 19, and token redemption 26 in the rewards marketplace 15, with return of such tokens to the brand 35. But in the public-traded tokens embodiments, fans can purchase incremental tokens 33 from a public exchange 22, as can non-fans, and brands can retain returned tokens 36 or sell them on the public exchange 37.

Although the preferred embodiments of the present invention have been disclosed for illustrative purposes, those skilled in the art will appreciate that many additions, modifications and substitutions are possible, without departing from the scope and spirit of the present invention.

What is claimed is:

1. A method for creating and sustaining an internet-based social marketplace for monetization of multiple social actions performed by multiple fans on behalf of multiple sponsoring brands, the method comprising the following steps:
(a) embedding an application software on multiple brand websites of the sponsoring brands;
(b) the fans accessing the brand websites and using the application software to connect to a web platform for the social marketplace;
(c) the web platform providing the fans access to an actions database of the social actions which are available to the fans and to a rewards database of multiple brand rewards offered in the social marketplace;
(d) the web platform establishing a normalized monetary value for the social actions and for the brand rewards;
(e) the fans utilizing a user interface of the application software to join the social marketplace;
(f) the fans performing social actions on behalf of the sponsoring brands through the application software embedded on the brand websites, or through one or more native or hybrid social media application softwares;
(g) incentivizing the social actions performed by the fans through issuance by the sponsoring brands of one or more cross-brand reward tokens, issued on a block-chain protocol and based on the normalized monetary value of the social actions performed and an established exchange rate of the cross-brand reward tokens;
(h) the fans expending the cross-brand reward tokens that are issued to redeem, through redemption transactions, the brands rewards in the social marketplace, based on the normalized monetary value of the brands rewards and the established exchange rate of cross-brand reward tokens, wherein the redemption transactions are tracked on the block-chain protocol;
(i) re-circulating the cross-brand reward tokens expended in the redemption transactions back to the sponsoring brands which issued the cross-brand received tokens; and
(j) the sponsoring brands reissuing the cross-brand reward tokens that have been re-circulated to incentivize further social actions performed by the fans.

2. The method according to claim 1, wherein, in step (g), the cross-brand reward tokens issued by the sponsoring brands are deposited in virtual wallets assigned to each of the fans, and wherein, in step (h), the fans expend the cross-brand reward tokens which have been deposited in the fans' virtual wallets.

3. The method according to claim 2, wherein, in step (e), the social marketplace is either an internal exchange or a public exchange, and wherein in steps (g) and (h), the established exchange rate of the cross-brand reward tokens fluctuates based on supply and demand for the cross-brand reward tokens, which are available for purchase and sale in either the internal exchange or on the public exchange.

4. The method according to claim 3, wherein, in step (e), the social marketplace is the internal exchange, and wherein in steps (g) and (h), the cross-brand reward tokens are available for purchase and sale by the fans only.

5. The method according to claim 3, wherein, in step (e), the social marketplace is the public exchange, and wherein in steps (g) and (h), the cross-brand tokens are available for purchase and sale by the fans, the sponsoring brands, or by non-fans.

6. The method according to claim 1, wherein, in step (g), the cross-brand reward tokens are allocated to each of the sponsoring brands based on the number of fans of the sponsoring brand and the level of social media activity of the sponsoring brand.

7. The method according to claim 2, wherein, in step (g), the cross-brand reward tokens are allocated to each of the sponsoring brands based on the number of fans of the sponsoring brand and the level of social media activity of the sponsoring brand.

8. The method according to claim 3, wherein, in step (g), the cross-brand reward tokens are allocated to each of the sponsoring brands based on the number of fans of the sponsoring brand and the level of social media activity of the sponsoring brand.

9. The method according to claim 4, wherein, in step (g), the cross-brand reward tokens are allocated to each of the sponsoring brands based on the number of fans of the sponsoring brand and the level of social media activity of the sponsoring brand.

10. The method according to claim 5, wherein, in step (g), the cross-brand reward tokens are allocated to each of the sponsoring brands based on the number of fans of the sponsoring brand and the level of social media activity of the sponsoring brand.
